(19) United States
(12) Patent Application Publication
(10) Pub. No.: US 2007/0216836 A1
(43) Pub. Date: Sep. 20, 2007

(54) Reducing reflection

(76) Inventor: Barret Lippey, Belmont, MA (US)

Correspondence Address: FISH & RICHARDSON PC, P.O. BOX 1022, MINNEAPOLIS, MN, 55440-1022, US

(21) Appl. No.: 11/378,510

(22) Filed: Mar. 17, 2006

(51) Int. Cl. G02F 1/1335

(52) U.S. Cl. 349/117

(57) ABSTRACT

A plate has a low birefringence and a retardation layer is characterized by a fast optical axis and a slow optical axis. The retardation layer is positioned with its fast optical axis at a rotation angle selected to reduce an s-polarized component of light passing through the retardation layer at a particular angle of incidence.

### TECHNICAL FIELD

This description relates to reducing reflection.

### BACKGROUND

Light from sources of information on the dashboards of automobiles can cast images on the windshield that are superimposed on the driver's or passenger's view through the windshield. Liquid crystal displays (LCDs) and other modem display devices used for information, navigation, and entertainment systems create larger sources of such reflected images than the basic displays of radios and other instruments used in the past. The increasing angle of windshields in modem, aerodynamic cars can result in more reflections from the dashboard into the driver's field of view.

### SUMMARY

In general, in one aspect, a plate has a low birefringence and a retardation layer is characterized by a fast optical axis and a slow optical axis. The retardation layer is positioned with its fast optical axis at a rotation angle selected to reduce an s-polarized component of light passing through the retardation layer at a particular angle of incidence.

Implementations may include one or more of the following features. A layer of pressure-sensitive adhesive is included. The pressure-sensitive adhesive has a low birefringence. A layer of antireflective material is included. The retardation layer includes a retardation film. The retardation layer includes two or more retardation films. The two or more retardation films are positioned with their fast optical axes at different rotation angles. The two or more retardation films are positioned with their fast optical axes at the same rotation angle. The two or more retardation films have different amounts of retardation. The particular angle of incidence is high as measured from a normal vector of the retardation layer. The particular angle of incidence is low as measured from a normal vector of the retardation layer. An LCD panel is included. The apparatus is configured to be installed in an automobile having a windshield, and the retardation layer is positioned to reduce the s-polarized component of light from the LCD panel passing through the retardation layer and towards the windshield. A backlight and a housing are included, and the assembly is adapted to be installed into a dashboard of a vehicle.

In general, in one aspect, a film is configured to be positioned between a light source and a reflective surface and to rotate a polarization of light from the light source to reduce reflection of the light by the reflective surface.

Implementations may include one or more of the following features. The film is configured to rotate a polarization of light from the light source by decreasing a magnitude of a polarization component of the light that is perpendicular to a plane defined by the angle of incidence of the light on the reflective surface. The light source includes an LCD panel. The reflective surface includes a windshield.

In general, in one aspect, the brightness of a display, when viewed through polarized sunglasses, is increased by placing a film in the path of light from the display, and the film is configured to rotate a polarization of light from the light source.

Implementations may include one or more of the following features. The film is configured to rotate the polarization light from the light source by 45 degrees. The film is configured to rotate the polarization of light from the light source to be p-polarized.

In general, in one aspect, a retardation film is affixed to a plate having a low birefringence at an angle of rotation selected to tend to reduce an s-polarized component of light passing through the retardation film.

Implementations may include one or more of the following features. Affixing includes applying pressure-sensitive adhesive to the plate, placing the retardation film in contact with the pressure-sensitive adhesive, and applying pressure to the retardation film in the direction of the plate. A second retardation film is rotated to a second angle, pressure-sensitive adhesive is applied to the first retardation film, the second retardation film is placed in contact with the pressure-sensitive adhesive, and pressure is applied to the second retardation film in the direction of the plate. Affixing the retardation film includes rotating a first retardation film to a first angle, and rotating a second retardation film to a second angle, in which the combination of the angles of the films tends to reduce an s-polarized component of light passing through the retardation films at a particular angle of incidence, and affixing the retardation film includes affixing the first and second retardation films.

Other general aspects include other combinations of the aspects and features described above and other aspects and features expressed as methods, apparatus, systems, program products, and in other ways.

Other features and advantages of the invention will be apparent from the following description and claims.

### DESCRIPTION

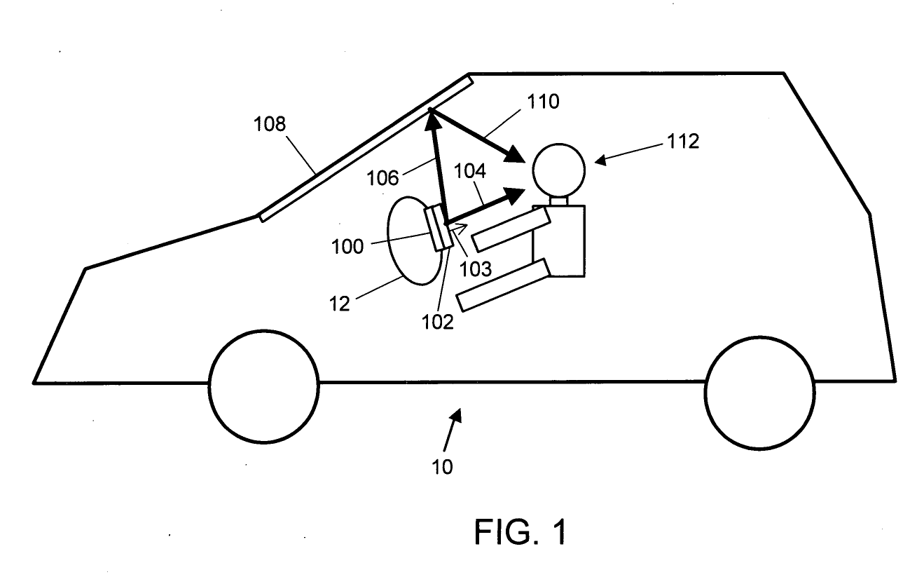

FIG. 1 is a schematic side view of a driver in a car.

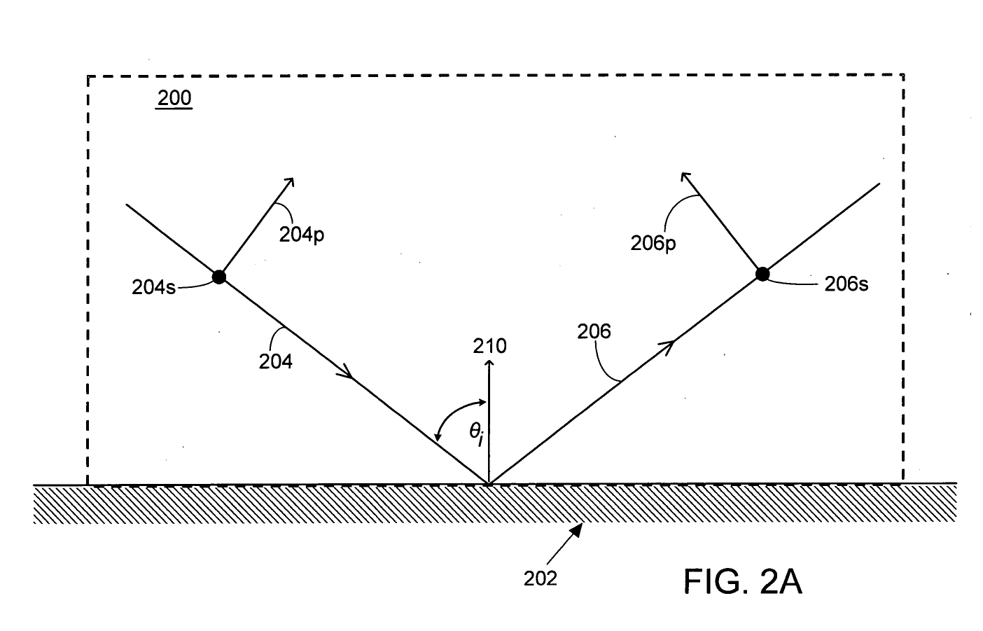

FIG. 2A is a diagram of reflection of light showing polarization components.

FIG. 2B is a graph of the reflectance of light as a function of incident angle.

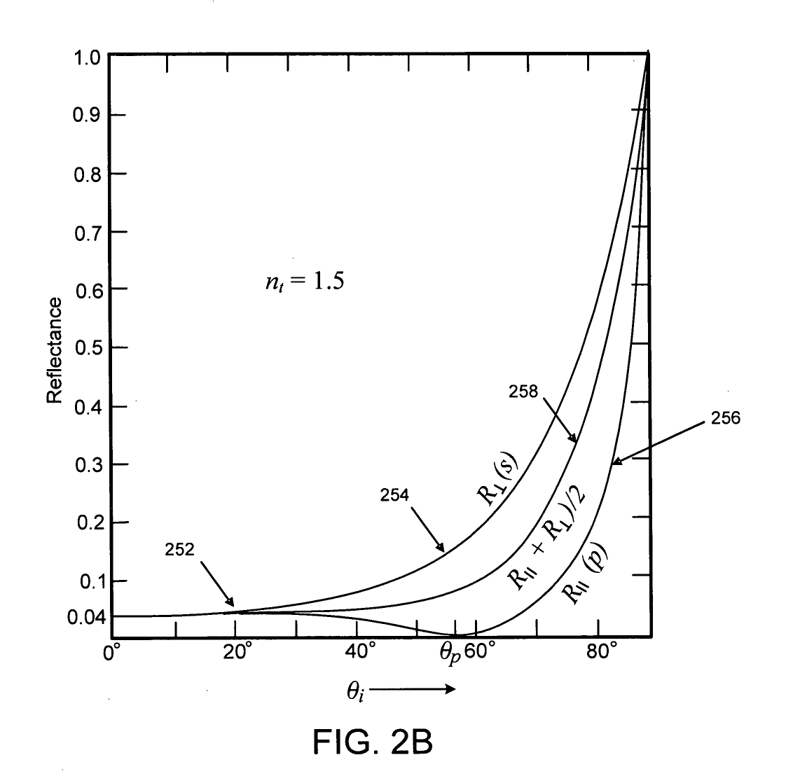

FIG. 3. is a schematic perspective view of a retardation film.

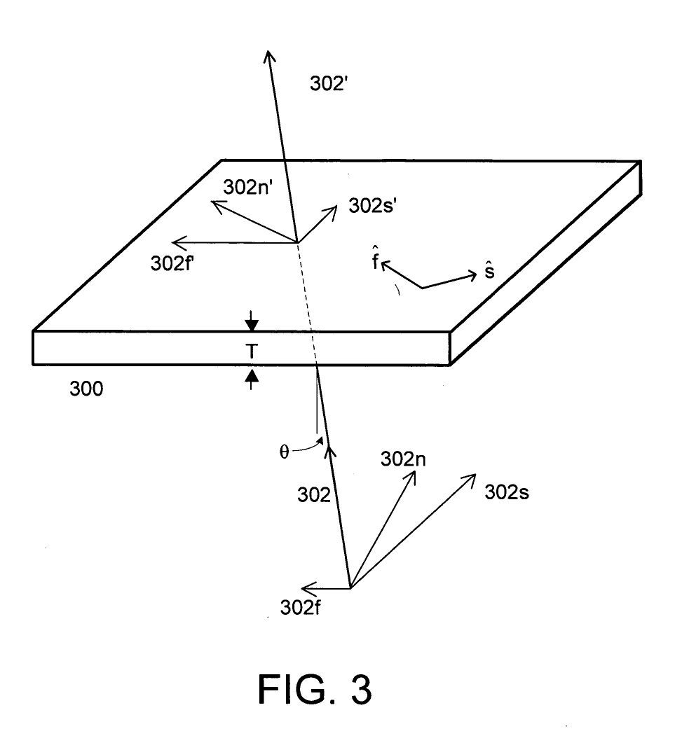

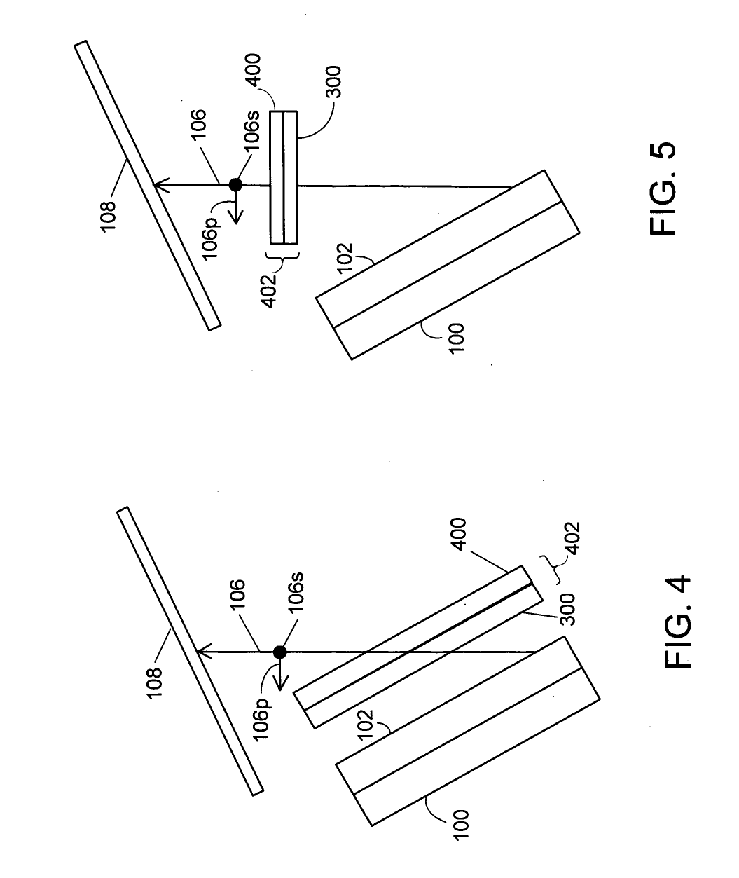

FIGS. 4 and 5 are schematic side views of components in a car.

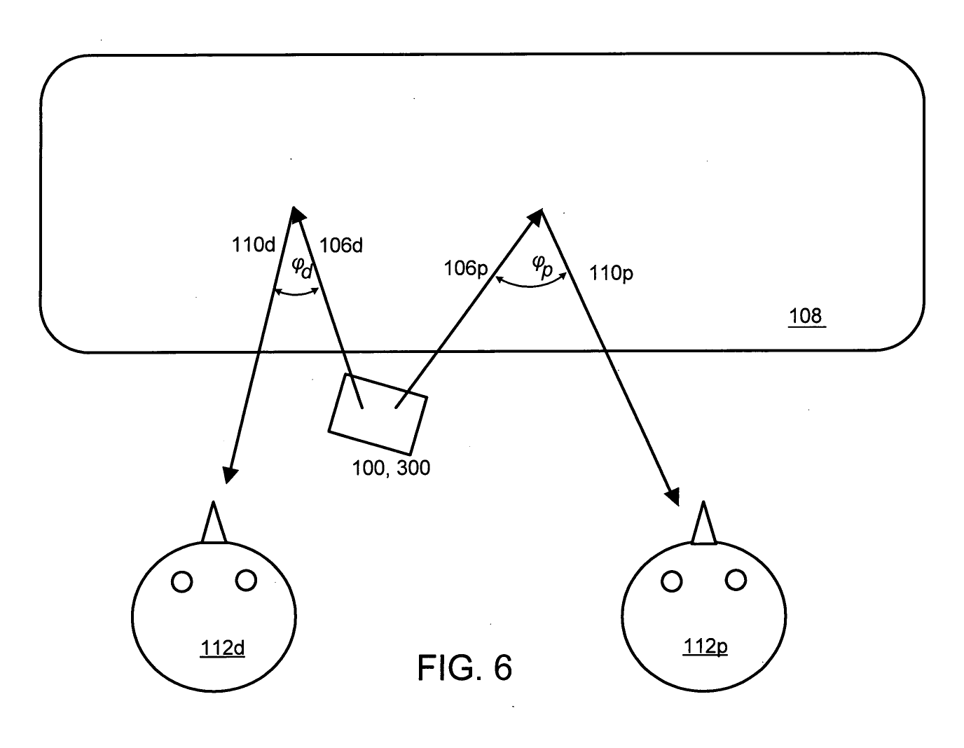

FIG. 6 is a schematic plan view of a driver and passenger in a car.

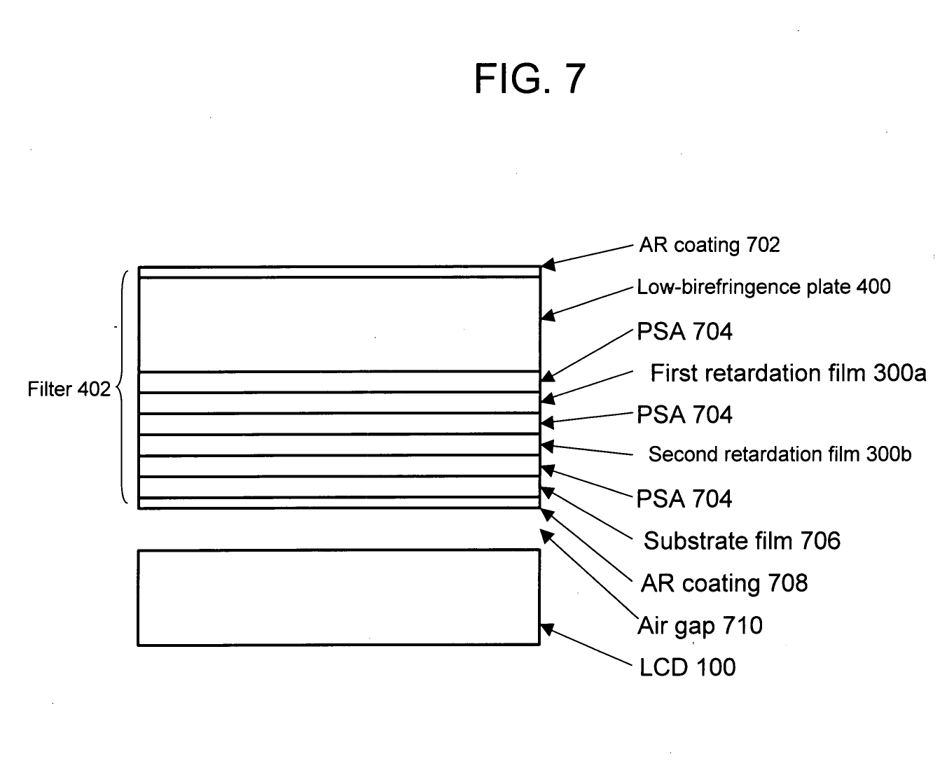

FIG. 7 is a schematic cross-section view of an optical filter.

As shown in FIG. 1, an LCD screen consist of a backlight 100 and a light valve panel 102 located in the dashboard 12 of a car 10. Light from the backlight 100 passes through the panel 102 in multiple directions. Direct light 104 strikes and travels through the panel 102 at a low angle relative to a vector 103 normal to the panel 102 and travels directly from the backlight 100 to a driver 112. Such light is referred to as light having a low angle of incidence. Indirect light 106 travels through the panel 102 at a high angle relative to the normal vector 103 of panel 102 and is reflected by windshield 108. Such light is referred to as light having a high angle of incidence. Depending on the specific angles involved, reflected light 110 may be visible to the driver 112, causing the driver to perceive a reflection of the panel 102 in the windshield 108. In some cases, this reflection is undesirable. Alternatively, in some cases, for example, a heads-up display, the reflected light 110 is intended to be visible to the driver and the direct light 104 is not.

The amount of indirect light 106 that is reflected by the windshield 108 to produce reflected light 110 depends, among other things, on the polarization of the indirect light 106. As shown in FIG. 2A, light can be characterized as including perpendicular polarization components referred to as the s-polarized and p-polarized components. These represent components of an electric field vector oscillating, or vibrating, in the corresponding direction. Light having only one component (that is, the other component has a magnitude of zero) is sometimes referred to by that component, e.g., “s-polarized light.” Consider a plane 200 perpendicular to a reflective surface 202, such that vectors 204 and 206 represent the direction of travel of incident and reflected light and both rays of light are contained within the plane 200. The s-polarized component 204s of the incident light 204 has an electric field vector vibrating perpendicular to the plane 200 (in and out of the page in FIG. 2A), and the p-polarized component 204p has an electric field vector vibrating in the plane 200. Both components are perpendicular to the direction of travel of incident light 204.

If reflective surface 202 is a smooth surface such as glass, the s-polarized component 204s of incident light 204 tends to be reflected more than the p-polarized component 204p, which tends to be transmitted more at certain angles rather than reflected. The amount of reflection for each component depends on the angle of incidence θᵢ. As shown in FIG. 2B, for a low angle of incidence, only a small part of both the s-polarized and the p-polarized components will be reflected, while for a high angle of incidence, nearly all of both components is reflected. In between, however, the components behave differently. At a point 252 on the graph, corresponding to an incident angle of about 20°, the reflectance of the s-polarized component (line 254) begins to substantially increase, while the reflectance of the p-polarized component (line 256) begins to substantially decrease. The reflectance of the p-polarized component reaches a minimum (no reflectance) at an angle θₚ before beginning to increase. The value of θₚ depends on the index of refraction of the material of the reflective surface. The index of refraction for most materials varies slightly with the wavelength of the incident light. The vertical axis of the graph is based on an index of refraction nₜ equal to 1.5. For other indices of refraction, the vertical axis of the graph would be different. The average reflectance (line 258) of the two components, equivalent to light having equal s-polarized and p-polarized components (or natural, unpolarized light), remains low until about θₚ and then begins to increase, such that all three lines approach complete reflectance as the angle of incidence approaches 90°.

Returning to FIG. 1, one way to decrease the brightness of reflected light 110 is to make sure that the indirect light 106 has a small s-polarized component and large p-polarized component, relative to the windshield 108, so that most of the indirect light 106 incident on the windshield 108 will be transmitted. As shown in FIG. 3, a retarding film 300 (also known as a polarization rotator) reorients the polarization of light passing through it. Commercially available retarding films include the OptiGrafix™ retarder films available from Grafix Plastics, Cleveland, OH. A retarding film has two optical axes, a fast axis \hat{f} and a slow axis ŝ (in FIG. 3, \hat{f} and ŝ are orthogonal to each other, in the plane of the retarding film 300, rotated 45° from the edges of the film). The rotation of the film describes rotation of the film about a normal vector through its center, and is measured by the angle between the fast axis and some external reference, such as the edge of the film. Depending on the orientation of the film, the speed of light passing through the film will be different in the two directions. The speed of incident light vibrating along the fast axis \hat{f} will be faster than the light vibrating along the slow axis ŝ. As a result, the polarization of linearly polarized light can be rotated.

For example, in FIG. 3, incident light 302 has a relatively larger component 302s, and a relatively smaller component 302f, resulting in a net polarization 302n. Retarding film 300 effectively rotates the polarization of incident light 302 so that exiting light 302′ has a relatively smaller component 302s′ and a relatively larger component 302f, resulting in a net polarization 302n′ at a substantially different angle than the original net polarization 302n.

The effect of the retarding film depends on its orientation relative to the polarization of the incoming light, its thickness T, and the angle of incidence θ. The amount by which each component is shortened or lengthened depends on how much of the retarding film material the light passes through. Light passing through the film at incident angles other than perpendicular passes through a greater amount of material, increasing its effect. In the case of a dashboard-mounted LCD panel 102, the light from the LCD has a known polarization and passes through the panel 102 and strikes the windshield 108 at known angles. As shown in FIG. 4, a thickness of retarding film 300 can be selected and the film positioned between the panel 102 and the windshield 108 such that the indirect light 106 will have a relatively larger p-polarized component 106p and smaller s-polarized component 106s and thereby minimize its reflection by the windshield 108.

In the example of FIG. 4, the retarding film 300 is laminated onto a low-birefringence plate 400 to form a filter 402. Birefringence is the property of a material where there are different indices of refraction depending on the direction of the light. Retardation films have high birefringence. A low-birefringence plate is one in which the index of refraction of light is nearly the same for all directions and is therefore the same for both orthogonal components of polarization, and is used in this example to reduce any effect the plate 400 may have on the polarization beyond the effect of the retarding film 300. Attaching the retarding film 300 to the plate 400 assures that the retarding film 300 is positioned at the proper incident angles relative to the light 106 from the LCD backlight 100 and LCD panel 102 and at the proper rotational angle relative to the horizontal and vertical axes of the LCD panel. The birefringence plate 400 also protects the retarding film 300 from damage, separating it from the environment. Commercially available low-birefringence plates include the Clarex® brand made by Nitto Jushi Kogyo, Tokyo, Japan.

With this arrangement, a retarding film configured to assure that light passing through at a high angle is p-polarized relative to the windshield 108 can have the beneficial side effect of increasing the brightness of the LCD when directly viewed by a driver wearing polarized sunglasses. Polarized sunglasses are typically designed to block s-polarized light (since sunlight reflected off a horizontal surface, such as the ground or water, will be s-polarized relative to that surface). Since light from small and medium size LCD screens is typically polarized at a 45 degree angle relative to horizontal, half of the energy of such light is blocked by polarized sunglasses, decreasing its apparent brightness. A retarding film configured to rotate the light to have a large p-polarized component relative to the windshield 108 can also be arranged to rotate the direct light 104 to have a large p-polarized component relative to the driver's sunglasses.

In some examples, as shown in FIG. 5, the filter 402, including the retarding film 300, is placed between the panel 102 and the windshield 108, but not in the driver's field of view. This can allow the filter 402 and the retarding film 300 to be reduced in size, as only a small aperture is necessary to intercept all of the light 106 shining from the LCD 100 to the windshield 108.

In some examples, it is desirable to reduce the reflection of the LCD screen for both the driver and the passenger, who may view the reflection in the windshield at different compound angles φ_{d} and φₚ, especially if the LCD screen is angled towards the driver, as shown in FIG. 6. Some indirect light 106d strikes the windshield 108 and is reflected to the driver at one angle φ_{d}, while other indirect light 106p strikes the windshield 108 at a different angle φₚ. An angle of polarization that reduces the intensity of the reflected light 110d seen by the driver 112d might increase the intensity of the reflected light 110p viewed by the passenger 112p. In such a case, the retarding film 300 may be configured to achieve a polarization that reduces the reflection for both driver and passenger, though typically not to as great an extent as could be achieved if it were optimized for only one seating position. Similarly, the actual position of the driver and passenger will vary with the height of each and the position of their seat. The retarding film may be configured to optimize the reduction in reflection for the greatest range of seating positions.

Retarding films are generally commercially available in a finite set of retardation values. As shown in FIG. 7, multiple layers of retarding film may be combined to achieve the retardation values needed to produce the desired adjustment to polarization. Layers of retarding film 300a and 300b are adhered to each other, to the low-birefringence plate 400, and to an underlying substrate film 706 with a pressure-sensitive adhesive (PSA) 704 having a low birefringence, such as the optical adhesives available from Adhesives Research, Glen Rock, Pa. Anti-reflective coatings 702 and 708 are deposited on adhered to the top and bottom of filter 402 to help prevent reflections from the top and bottom surfaces. The assembled filter 402 is separated from the LCD panel 102 by an air gap 710. Different layers of retardation films may be positioned with their fast axes at different rotational angles to achieve a desired effect. The specific rotational angles chosen will depend on the angle of the windshield 108 relative to the LCD panel 102, the positions of the driver and passenger, and the polarization angle of the light generated by the LCD panel 102. In one case, it was found that a film with 165 nm of retardation at a wavelength of 560 nm and a film with 300 nm of retardation at a wavelength of 560 nm with their fast axes rotated 13 degrees counterclockwise from the vertical axis of the LCD produced the minimum amount of reflection from the windshield of a test vehicle for both the driver and passenger positions. In another case, two layers of 250 nm retardation film were each rotated at 90 degrees relative to each other with the back layer rotated 14 degrees counterclockwise from the screen horizontal and the front layer rotated 14 degrees counterclockwise from the screen vertical.

Other implementations are within the scope of the claims. For example, the retarding film may be included in the LCD screen as part of the manufacturing process. A display based on liquid crystal on silicon (LCOS) or other technology could be used.

What is claimed is:

1. An apparatus comprising
a plate having low birefringence, and
a retardation layer characterized by a fast optical axis and a slow optical axis,
and in which the retardation layer is positioned with its fast optical axis at a rotation angle selected to reduce an s-polarized component of light passing through the retardation layer at a particular angle of incidence.

2. The apparatus of claim 1 also comprising a layer of pressure-sensitive adhesive.

3. The apparatus of claim 2 in which the pressure-sensitive adhesive has a low birefringence.

4. The apparatus of claim 1 also comprising a layer of antireflective material.

5. The apparatus of claim 1 in which the retardation layer comprises a retardation film.

6. The apparatus of claim 1 in which the retardation layer comprises two or more retardation films.

7. The apparatus of claim 6 in which the two or more retardation films are positioned with their fast optical axes at different rotation angles.

8. The apparatus of claim 6 in which the two or more retardation films are positioned with their fast optical axes at the same rotation angle.

9. The apparatus of claim 6 in which the two or more retardation films have different amounts of retardation.

10. The apparatus of claim 1 in which the particular angle of incidence is high as measured from a normal vector of the retardation layer.

11. The apparatus of claim 1 in which the particular angle of incidence is low as measured from a normal vector of the retardation layer.

12. The apparatus of claim 1 also comprising an LCD panel.

13. The apparatus of claim 12 in which
the apparatus is configured to be installed in an automobile having a windshield, and
the retardation layer is positioned to reduce the s-polarized component of light from the LCD panel passing through the retardation layer and towards the windshield.

14. An apparatus comprising a film configured to be positioned between a light source and a reflective surface and to rotate a polarization of light from the light source to reduce reflection of the light by the reflective surface.

15. The apparatus of claim 14 in which the film is configured to rotate a polarization of light from the light source by decreasing a magnitude of a polarization component of the light that is perpendicular to a plane defined by the angle of incidence of the light on the reflective surface.

16. The apparatus of claim 14 in which the light source comprises an LCD panel.

17. The apparatus of claim 14 in which the reflective surface comprises a windshield.

18. A method comprising
decreasing reflections from a light source by placing a film between the light source and a reflective surface, the film being configured to rotate a polarization of light from the light source.

19. The method of claim 18 in which the film is configured to rotate a polarization of light from the light source by decreasing a magnitude of a polarization component of the light that is perpendicular to a plane defined by the angle of incidence of the light on the reflective surface.

20. The method of claim 18 in which the light source comprises an LCD panel.

21. The method of claim 18 in which the reflective surface comprises a windshield.

22. A method comprising
increasing the brightness of a display, when viewed through polarized sunglasses, by placing a film in the path of light from the display, the film being configured to rotate a polarization of light from the light source.

23. The method of claim 22 in which the film is configured to rotate the polarization light from the light source by 45 degrees.

24. The method of claim 22 in which the film is configured to rotate the polarization of light from the light source to be p-polarized.

25. A method comprising
affixing a retardation film to a plate having a low birefringence at an angle of rotation selected to tend to reduce an s-polarized component of light passing through the retardation film.

26. The method of claim 25 in which the affixing comprises
applying pressure-sensitive adhesive to the plate,
placing the retardation film in contact with the pressure-sensitive adhesive, and
applying pressure to the retardation film in the direction of the plate.

27. The method of claim 25 also comprising
rotating a second retardation film to a second angle,
applying pressure-sensitive adhesive to the first retardation film,
placing the second retardation film in contact with the pressure-sensitive adhesive, and
applying pressure to the second retardation film in the direction of the plate.

28. The method of claim 25 in which
affixing the retardation film comprises
rotating a first retardation film to a first angle, and
rotating a second retardation film to a second angle,
in which the combination of the angles of the films tends to reduce an s-polarized component of light passing through the retardation films at a particular angle of incidence, and
affixing the retardation film comprises affixing the first and second retardation films.

29. An apparatus comprising
a liquid-crystal display,
a plate having low birefringence, and
a retardation layer characterized by an axis of polarization,
and in which the retardation layer is positioned with its axis of polarization rotated to an angle selected to tend to reduce an s-polarized component of light passing from the liquid-crystal display and through the retardation layer at a particular angle of incidence.

30. The apparatus of claim 29 also comprising a backlight and a housing,
and adapted to be installed into a dashboard of a vehicle.
